(19) United States
(12) Patent Application Publication
(10) Pub. No.: US 2025/0371544 A1
(43) Pub. Date: Dec. 4, 2025

(54) DEVICES, SYSTEMS, AND METHODS FOR ENHANCING TRANSACTION SECURITY AND REDUCING FRAUD

(71) Applicant: The PNC Financial Services Group, Inc., Pittsburgh, PA (US)

(72) Inventors: Erik Solinger, Beaver, PA (US); Michael Smith, Kent, OH (US); Michael Frank, Murrysville, PA (US)

(21) Appl. No.: 18/677,204

(22) Filed: May 29, 2024

(51) Int. Cl. G06Q 20/40; G06Q 20/10

(52) U.S. Cl. CPC G06Q 20/4016; G06Q 20/1085

(57) ABSTRACT

Computer-implemented method enhances transaction security and reduces fraud for financial transactions made through any of a plurality of financial transaction channels. The method can include receiving a data file comprising a data item captured by a financial transaction initiating channel, identifying data relevant to the financial transaction based on the data item, identifying a source of data relevant to the financial transaction, capturing data relevant to the financial transaction from the source of data, calculating a confidence score for the financial transaction based on the data, and transmitting the confidence score to the financial transaction initiating channel to influence how the financial transaction is processed.

### BACKGROUND

The concept of Day 2 processing has been commonly adopted by service providers (e.g., financial institutions, financial technology or “fintech” companies, etc.) to review and approve a transaction (e.g., cashing a check, wiring money, electronic transfers, etc.) via an Automated Clearing House (“ACH”) network. Such transactions may be subject to certain exceptions, which can prohibit completion. For example, conventional systems may deploy conventional processing techniques to either process or decline a transaction request based on various considerations, including insufficient funds, stop payment, closed account, frozen/blocked account, signature(s) missing, signature(s) irregular, and/or post date, amongst others. Although exceptions often occur within a single day of a transaction initiation, some exceptions are not recognized until a later date.

However, existing processing techniques are flawed, specifically for transactions initiated via check presentment. As an initial matter, existing processing techniques are reactive, reserving a full item analysis for post-processing instead of pre-processing or at the point of presentment. Additionally, there is a lack of transparency into issues that occur at presentment, and processes can vary based on channel, resulting in customer confusion and the potential for exploitation by bad actors. Such variation has conventional means of processing that are inefficient and susceptible to gamification. Thus, existing processing techniques have resulted in a rapid increase in fraud, even though the volume of check presentment continues to decrease.

### SUMMARY

In one general aspect, the present invention is directed to computer-implemented systems and methods that are configured to enhance transaction security and reduce fraud for financial transactions initiated across a plurality of channels in a consistent and streamlined manner, regardless of channel differences. The system, for example, can include a review, analysis and transaction enrichment (“RATE”) computing device communicably coupled to each of the plurality of channels via an application programming interface (“API”). The RATE computing device can include a processor and a memory configured to store a RATE engine. When executed by the processor, the RATE engine can cause the RATE computing device to receive an item associated with a transaction initiated by a channel of the plurality of channels. Based on this item, the RATE engine can identify data relevant to the transaction (e.g., information associated with the item or a party to the transaction) as well as a source of the identified data. The RATE engine can retrieve the identified data from the identified source and use it to calculate a “confidence score” for the transaction. The RATE engine can transmit the “confidence score” for the transaction to the transaction initiating channel.

### FIGURES

Various aspects of the present invention are described herein by way of example in connection with the following figures.

FIG. 1 is a block diagram of a system configured to enhance transaction security and reduce fraud according to at least one non-limiting aspect of the present disclosure.

FIG. 2 is a flow diagram of a method of enhancing transaction security and reducing fraud according to at least one non-limiting aspect of the present disclosure.

FIG. 3 is an extensible framework of the RATE engine employed by the system of FIG. 1 according to at least one non-limiting aspect of the present disclosure.

FIGS. 4 and 5 represent an architecture of the system of FIG. 1 according to at least one non-limiting aspect of the present disclosure.

### DESCRIPTION

As previously discussed, conventional devices, systems, and methods for processing transactions are reactive (e.g., post-processing) and not proactive (e.g., at the time of presentment). However, as the technology used to process transactions continues to evolve, conventional processes have stagnated. Although such stagnation has been partially driven by the need for regulatory compliance, the introduction of mainframes, increasing number of digital channels through which transactions are initiated, and the need for real-time processing has inhibited transaction processing techniques from becoming more proactive. As used herein, a “channel” shall include a means of exposing internal services (e.g., collections, payments, etc.) to consumers (e.g., customers. other financial institutions, companies, etc.) in a controlled manner. Accordingly, improved devices, systems, and methods are necessary to enhance transaction security and reduce fraud.

Such devices, systems, and methods must provide several technological improvements over conventional devices, systems, and methods. For example, the devices, systems, and methods disclosed herein are technologically compatible with a number of different channels through which various transactions are initiated. The devices, systems, and methods disclosed herein are also capable of integrating with new channels as they are introduced. In other words, the devices, systems, and methods disclosed can provide consistency, enhancing transaction security and reducing fraud in a similar manner, regardless of channel. This promotes standardization across channels and thus, makes it easier to manage regulatory compliance. Moreover, the devices, systems, and methods disclosed herein are also capable of interfacing with numerous sources of information and generating unprecedented insights based on that information in real-time (e.g., at the moment of presentment) to proactively enhance security and reduce fraud. Finally, the integrations utilized by the devices, systems, and methods disclosed herein enable more efficient transaction processing with fewer computational resources by using a common transaction evaluation service for multiple channels. Furthermore, the devices, systems, and methods disclosed herein can proactively generate insights on which several autonomous actions can be based to enhance security. Such practical applications will be discussed in further detail herein.

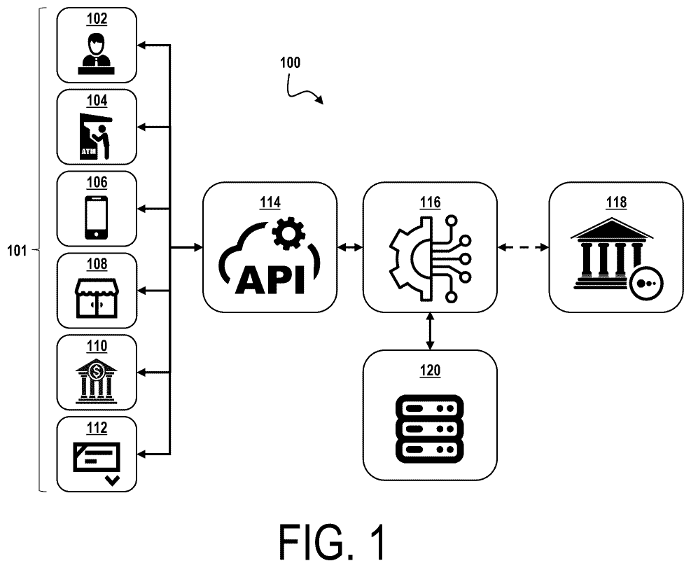

Referring now to FIG. 1, a block diagram of a system 100 configured to enhance transaction security and reduce fraud is depicted according to at least one non-limiting aspect of the present disclosure. According to the non-limiting aspect of FIG. 1, the system 100 can include a plurality of channels 101 configured to communicate with a review, analysis and transaction enrichment (“RATE”) engine 116 via an application programming interface (“API”) 114. It shall be appreciated that the RATE engine 116 can be stored in a memory of a RATE computing device, which can further include a processor configured to execute the RATE engine 116 to perform the functionality described herein. The RATE engine 116 can include one or more interfaces providing abstraction to internally orchestrated or choreographed calls, which can perform an analysis of an item presented by one of the plurality of channels, save data for future use, etc. The plurality of channels 101, for example, can include a banking device 102 (e.g., a teller's computer), an automatic transaction machine (“ATM”) 104, a personal computing device 106 (e.g., a personal computer, a laptop, a mobile phone, a tablet, etc.), a point-of-sale (“POS”) device (e.g., deployed at a small business) 108, a corporate and/or institutional banking (“C&IB”) device 110, and/or an inclearings device 112, amongst other channels. It shall be appreciated that the plurality of channels 101 depicted in FIG. 1 is non-exclusive and that the system 100 promotes channel modernization. The API 114 is representative of one or more APIs which are configured to be consumable by any channel of the plurality of channels 101 providing specific interfaces, some of which will communicate with the RATE engine 116. In other words, the system 100 and API 114 of FIG. 1 provides a standard configuration by which any channel of an extensible plurality of channels 101 can communicate with the RATE engine 116. However, the rules by which any channel of the plurality of channels 101 can be customized, such that each channel of the plurality of channels 101 can function independently relative to the others. The plurality of channels 101 can utilize a number of different formats to communicate messages to and from the API 114, including real-time gross settlement (“RTGS”), national electronic funds transfer (“NEFT”), electronic clearing service (“ECS”), immediate payment service (“IMPS”), Society for Worldwide Interbank Financial Telecommunications (“SWIFT”), short messaging service (“SMS”) banking, Internet banking, and/or automatic teller machine (“ATM”) Banking, amongst others. The API 114 can be configured to communicate with any of these formats via an industry standard messaging protocol, such as ISO 8583, REST, GraphQL, and/or SOAP, amongst others.

As depicted in the non-limiting aspect of FIG. 1, the API 114 can enable each of the plurality of channels 101 to selectively communicate with the RATE engine 116. The API 114, for example, can enable each of the plurality of channels 101 to communicate with the RATE engine 116 over a network, using a common language and/or protocol. In other words, the API 114 can be configured to convey a set structure for requests and responses so data can transfer between each of the plurality of channels 101 and the RATE engine 116. Upon initiating a request to evaluate based on an item (e.g., a check, a wire, an ACH transaction, a real-time payment (“RTP”)), any of the plurality of channels 101 can generate an API call comprising a transaction request, which can be transmitted to the RATE engine 116 via the API 114. The transaction, for example, can involve a transfer of funds from a payor's account to a payee's account. According to some non-limiting aspects, the transaction request can include an item submission. An “item,” as used herein, can include an instrument, a promise, or order to pay money handled by a bank for collection or payment. For example, an item can include a check or a picture of a check.

In further reference to FIG. 1, the RATE engine 116 can include instructions and/or a model stored in a memory and configured to be executed by a processor. When executed by the processor, the RATE engine 116 can cause the processor to receive a call associated with a transaction initiated by one of the plurality of channels 101. In response to the call, the RATE engine 116 can retrieve data associated with the transaction from one or more sources. For example, if the RATE engine 116 is hosted by a financial institution 118 involved in the transaction, the RATE engine 116 can directly access information relevant to the transaction, itself, or a party to the transaction from the financial institution 118. For example, according to such non-limiting aspects, the transaction might involve funds moving to or from an account hosted by the financial institution 118. Accordingly, the RATE engine 116 can retrieve information from the financial institution 118 such as an account status, an account balance, a signature verification, and/or an item verification, amongst other information relevant to the transaction and within the possession of the financial institution 118. The information can further include customer specific insights including behavioral insights, spending patterns, and/or a party's history, amongst others.

However, according to some non-limiting aspects, the RATE engine 116 may not be associated with a financial institution 118 involved in the transaction, or any financial institution at all. Even if the RATE engine 116 does not have direct access to the financial institution 118 involved in the transaction, the RATE engine 116 can otherwise access information relevant to the transaction and/or parties via one or more alternate sources of data 120. For example, the one or more alternate sources of data 120 can include any third-party database, website, or portal by which the RATE engine 116 can access relevant information such as an entity status, a credit score, employment history, spending activity, social media activity, dark web activity, and/or a criminal record, among other information. It shall be appreciated that various components of the system 100, including the plurality of channels 101 the API 114, the RATE engine 116, the financial institution 118, and computing devices associated therewith, and the at least one alternate data source 120 can be configured to communicate via various networks, such as the Internet and/or a payment network, such as ACH.

The RATE engine 116, therefore, can be configured to generate transaction insights based on the information it receives from the financial institution 118 and/or the one or more alternate sources of data 120. Transaction insights, for example, can increase visibility to potential transactions. For example, the RATE engine 116 can generate a confidence score associated with the transaction or a particular party of the transaction, upon which the initiating channel of the plurality of channels 101 can take certain actions. A “confidence score,” as used herein, can include an estimated probability that the requested transaction will be executed as requested. A confidence score can further result in further scrutiny prior resulting in either denial or approval of the transaction upon submission. For example, according to some non-limiting aspects, the confidence score can include an estimated probability of a presented check clearing. It shall be appreciated that such insights can imbue the plurality of channels 101 with a dynamic capability to predict transaction success in the pre-processing stage. As such, the system 100 of FIG. 1 can more proactively manage transactions far beyond the capabilities of conventional systems.

In other words, the system 100 of FIG. 1 can enable each channel of the plurality of channels 101 to utilize the RATE engine 116 to proactively acquire relevant information and insights for a transaction prior to transaction processing, thereby reducing the steps to react when BankOps must engage. It shall be further appreciated that the system 100 of FIG. 1-and more specifically, the API 114-enables each of the plurality of channels 101 to customize its own use of data and insights provided by the RATE engine 116 while standardizing the way each of the plurality of channels 101 accesses the RATE engine 116. This facilitates modernization for each of the plurality of channels 101 while ensuring use of the same centralized RATE engine 116. Thus, the system 100 of FIG. 1 streamlines and standardizes configurations for any number of channels 101, reducing the risks of gamification that can occur from individual configurations and security measures. Moreover, the system 100 of FIG. 1 is extensible and can be modified to provide additional white label services.

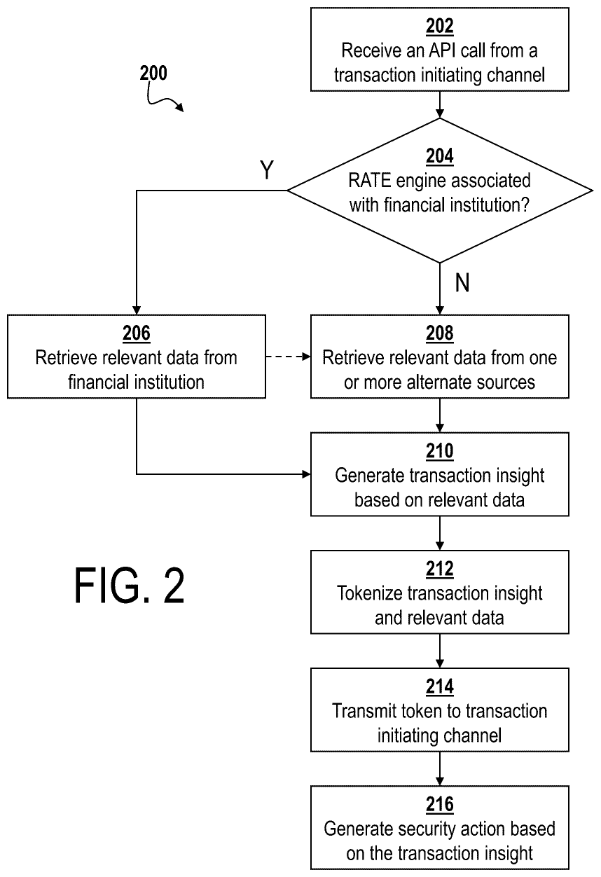

Referring now to FIG. 2, a flow diagram of a method 200 of enhancing transaction security and reducing fraud is depicted according to at least one non-limiting aspect of the present disclosure. It shall be appreciated that the method 200 of FIG. 2, for example, can be employed by the RATE engine 116 of the system 100 of FIG. 1. According to the non-limiting aspect of FIG. 2, the method 200 can include receiving 202 an API call from a transaction initiating channel of the plurality of channels 101. The method can further include determining 204 if the RATE engine 116 (FIG. 1) is associated with a financial institution 118 (FIG. 1) involved in the transaction. For example, if the RATE engine 116 (FIG. 1) is hosted by or has otherwise been granted access to information hosted by a financial institution 118 (FIG. 1) involved in the transaction, the RATE engine 116 (FIG. 1) can consume information relevant to the transaction.

According to non-limiting aspects wherein the RATE engine 116 (FIG. 1) is associated with the financial institution 118 (FIG. 1), the method 200 can further include retrieving 206 relevant data from the financial institution 118 (FIG. 1). However, according to non-limiting aspects where the RATE engine is not associated with the financial institution 118 (FIG. 1), the method 200 can further include retrieving 208 relevant data from the one or more alternate sources of data 120 (FIG. 1). However, according to still other non-limiting aspects, the RATE engine can be associated with the financial institution but the method 200 can still include retrieving 208 relevant data from one or more alternate sources of data 120 (FIG. 1) for use in conjunction with the relevant data retrieved from the financial institution 118 (FIG. 1).

In further reference to FIG. 2, the method 200 can further include generating 210 transaction insights, such as a confidence score, based on the relevant data. It shall be appreciated that, according to some non-limiting aspects, the transaction insights can be statistically generated based on relevant data from the financial institution 118 (FIG. 1) and/or the one or more alternate sources of data 120 (FIG. 1). The transaction insight, for example, can include a confidence score, or a probability that a transaction will be successfully completed based on population parameters (e.g., relevant data) falling between a set of values for a certain proportion of times. However, according to other non-limiting aspects, the transaction insights can be generated using a machine learning model. For example, the machine learning model can be configured to utilize supervised learning—which trains a model on known input and output data so that it can predict future outputs—and unsupervised learning—which finds hidden patterns or intrinsic structures in input data.

The method 200 of FIG. 2 can further include tokenizing 212 the generated transaction insights and other relevant data, which can increase the security for transmission via a payment network (e.g., RTP network, ACH network, electronic payments network (“EPN”), etc.) and can be used across intra-bank or inter-bank connections. For example, one of the plurality of channels 101 (FIG. 1) can communicate with the API 114 (FIG. 1) and process the item via RATE engine 116 (FIG. 1) to get the score and token. The channel 101 (FIG. 1) can determine what it wants to do before sending to another intra-bank payment service which can use that same token. As used herein, “tokenization” can mean creating a unique token for each instance of data, thereby minimizing the exposure of sensitive information during transmission. The token can also be used as an access key in the future if an item is presented for processing and/or an operational support team, service, and/or automation needs to be engaged. According to some non-limiting aspects, the transaction insights and other relevant data can be encrypted or converted into an unreadable format. Upon tokenization, the method 200 can include transmitting 214 the generated tokens to the transaction initiating channel of the plurality of channels 101 (FIG. 1).

According to the non-limiting aspect of FIG. 2, the method 200 can further include generating 216 a security action based on the transaction insight. For example, according to some non-limiting aspects, the RATE engine 116 (FIG. 1) and/or the transaction initiating channel of the plurality of channels 101 (FIG. 1) can generate and/or implement the security action. According to some non-limiting aspects, the security action can include denying the transaction request, blocking access to an implicated account, resetting a password, monitoring an implicated account, cancelling a card and/or other credential associated with an implicated account, and/or establishing a maximum transaction amount for future transaction requests involving an implicated account, amongst other security actions. Such security actions can be customized for each channel of the plurality of channels 101 (FIG. 1) via one or more rules programmed via the API 114 (FIG. 1).

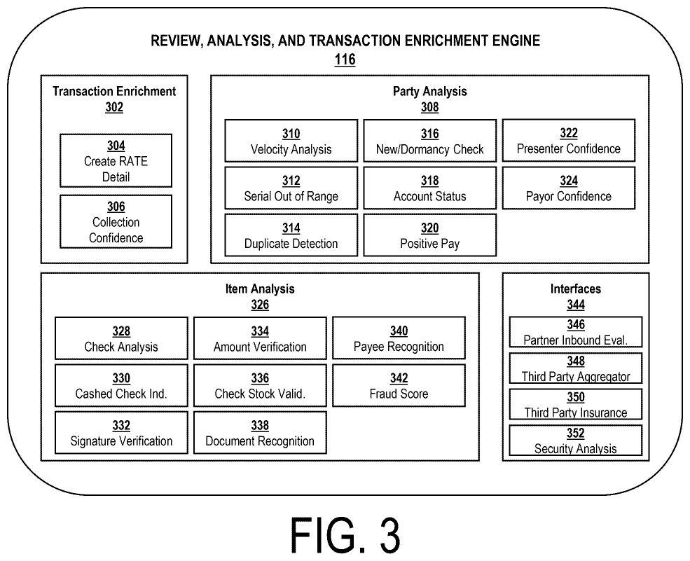

Referring now to FIG. 3, an extensible framework of the RATE engine 116 employed by the system 100 of FIG. 1 is depicted according to at least one non-limiting aspect of the present disclosure. According to the non-limiting aspect of FIG. 3, the RATE engine 116 can include a transaction enrichment module 302, a party analysis module 308, an item analysis module 326, configured to process relevant data received from the financial institution 118 (FIG. 1) and the one or more alternate sources of data 120 (FIG. 1) and generate transaction insights as previously described. The RATE engine 116 can receive relevant data and/or transmit transaction insights to and from the API 114 (FIG. 1), the financial institution 118 (FIG. 1), and the one or more alternate sources of data 120 (FIG. 1) via an interface module 344, as depicted in FIG. 3.

The interface module 344 of the RATE engine 116 of FIG. 3, for example, can include a third party aggregator interface 348, a third party insurance interface 350, and/or a security analysis interface 352, amongst others. Accordingly, the interface module 344 can include a partner inbound evaluation interface 346 based on inputs received from the one or more interfaces and/or information received from the transaction enrichment module 302, the party analysis module 308, and/or the item analysis module 326.

In further reference to FIG. 3, the transaction enrichment module 302 of the RATE engine 116 can be configured to generated transaction insights. For example, those insights can include a RATE detail 304 associated with the transaction and a collection confidence score 306 based on inputs received from the party analysis module 308, the item analysis module 326, and/or the interface module 344. The party analysis module 308 can be configured to receive and/or determine information relevant to one or more parties associated with the transaction initiated by one of the plurality of channels 101 (FIG. 1). For example, the party analysis module 308 can be configured to perform a velocity analysis 310 on a party, a new/dormancy party check 316, determine if a serial associated with the party is out of range 312, detect if the party initiated a duplicate transaction 314, determine an account status 318 associated with the party, and/or determine if the party uses positive pay 320. Based on such relevant data, the party analysis module 308 can generate a transaction insight, such as a payor confidence score 324 and/or a payee (e.g., presenter) confidence score 322.

Still referring to FIG. 3, the item analysis module 326 can be configured to receive and/or determine information relevant to one or more items associated with the transaction initiated by one of the plurality of channels 101 (FIG. 1). For example, the item analysis module 326 can be configured to perform a check analysis 328, detect a cashed check indication 330, perform a signature verification 332, perform an amount verification 334, perform a check stock validation 336, perform a document recognition 338, perform a payee recognition 340, and/or generate a fraud score 342 based on relevant data. In other words, the RATE engine 116 of FIG. 3 can provide a novel determination of transaction insights indicative of the probability a transaction (e.g., a presented check) will clear, enabling future dynamic channel 101 (FIG. 1) experiences. The extensible framework of FIG. 3 is configured for use across a variety of payment rails employed by the plurality of channels 101 (FIG. 1) and provides far more than a simple item analysis. Rather the extensible framework of FIG. 3 provides a wholistic understanding of a transaction by incorporating party and other data. It shall be appreciated that, via the RATE engine 116 of FIG. 3, activities and/or analyses conventionally performed via Day 2 techniques can be conducted up-front. Moreover, the RATE engine 116 of FIG. 3 can store the relevant data generated insights associated with a transaction as well as implicated accounts and parties. Accordingly, such insights are accessible for future use by bank operations, fraud, and machine learning teams via unique keys. According to non-limiting aspects wherein the transaction insights are generated via machine learning techniques, it shall be appreciated how more data will yield more accurate and enhanced insights.

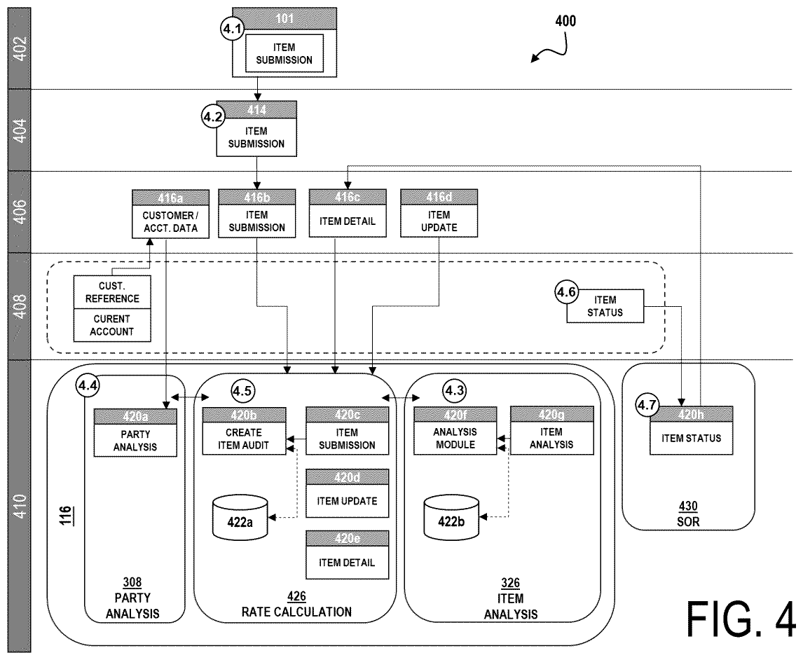

Referring now to FIG. 4, a first portion of an architecture 400 of the system 100 of FIG. 1 is depicted according to at least one non-limiting aspect of the present disclosure. At least a portion of the architecture 400, for example, can be employed via one or more computing devices that implement the system 100 of FIG. 1, such as a back-end computing device configured to host the RATE engine 116 (FIG. 1). According to the non-limiting aspect of FIG. 4, the architecture 400 can include a user interface layer 402, an outer layer 404, an inner layer 406, a data processing layer 408, and/or a system-of-record layer 410.

Still referring to FIG. 4, the user interface layer 402 can be implemented via software deployed by the plurality of channels 101 (FIG. 1). The user interface layer 402 can be configured to handle the presentation of information to users of the plurality of channels 101 (FIG. 1) and capture user inputs. It shall be appreciated that the user interface layer 402 can be configured to interface with the API 114 (FIG. 1), such that the plurality of channels 401 can communicate with the outer layer 404, the inner layer 406, the data processing layer 408, and the system-of-record layer 410. The flow of data between the outer layer 404 to the inner layer 406 is representative of data flow facilitated by the API 114 of FIG. 1. For example, a channel 101 (FIG. 1) can communicate with the API 114 (FIG. 1) and the API (FIG. 1) can call the system-of-record layer 410 for processing. According to some non-limiting aspects, the data processing layer 408 can be optional in another organization's technical implementation. However, according to some non-limiting aspects, the data processing layer 408 can be utilized to facilitate speed and efficiency in execution. Accordingly, the user interface layer 402 can include one or more channels 101 configured to initiate a transaction, for example, by submitting an item (e.g., an image associated with check presentation).

The outer layer 404 can include the requisite infrastructure for management of individual microservices deployed by the architecture 400 of FIG. 4, facilitating their discovery, routing, and ultimate configuration. For example, upon the channel 101 initiating a transaction, for example, by submitting the item, a service 414 of the outer layer 404 can determine how to disposition the item throughout the rest of the architecture 400 and do so accordingly. The inner layer 406 can include a plurality of services 416_{a-d} that perform different functions associated with the item submission received from the service 414 of the outer layer 404. For example, an inner write service 416_{b} can submit the item to the data processing layer 408, and/or a system-of-record layer 410. Another inner write service 416ₐ can submit item updates to the data processing layer 408, and/or a system-of-record layer 410. An inner read service 416ₐ can transmit relevant information, such as customer and/or account data associated with the transaction (e.g., a customer reference, a current account, etc.), to and from the data processing layer 408, and/or a system-of-record layer 410. Another inner read service 416_{c} can submit item details to the data processing layer 408, and/or a system-of-record layer 410.

According to the non-limiting aspect of FIG. 4, the data processing layer 408 can receive, process, and/or transmit data received from the inner layer 406 and/or the system-of-record layer 410, including customer references, account information, and information associated with the item. Finally, the system-of-record layer 410 configured to function as an information storage and retrieval system that accesses and stores relevant data to the transaction, or item.

In further reference to FIG. 4, the system-of-record layer 410 can contain multiple data sources and exist at a single location or multiple locations with remote access. The RATE engine 116 of the system 100 (FIG. 1) can be configured to exist on the system-of-record layer 410, including the party analysis module 308 and item analysis module 326 described in reference to FIG. 3.

Each of the party analysis module 308, the item analysis module 326, and the RATE calculation module 426 can be configured to perform a plurality of services 420_{a-g}. For example, the party analysis module 308 can execute a service 420ₐ to perform an analysis of parties associated with the transaction based on data received from the financial institution 118 (FIG. 1). The item analysis module 326 can include an analysis module 420_{f} configured to perform a service 420_{g} to analyze items (e.g., an image of a check, a signature, a document, etc.) associated with the transaction based on information provided by the party analysis module 308 and RATE calculation module 426, as well as configured rules stored in a storage device 422_{b.} Results from the item analysis module 420_{f} and service 420_{g} can be stored in the storage device 422_{b}.

The RATE calculation module 426 can be configured to calculate transaction insights, such as a confidence score, based on information provided by the party analysis module 308, information provided by the item analysis module 326, and configured rules stored in a storage device 422ₐ, including relevant information received from the financial institution 118 (FIG. 1). However, if the RATE engine 116 is not associated with the financial institution 118 (FIG. 1), the party analysis can be based on data received from the one or more alternate sources of data 120 (FIG. 1). The RATE calculation module 426 can execute a service 420_{b} to create an item audit based on a service for the item submission 420_{c}, a service for the item detail 420_{d}, and a service for the item update 420ₑ. Results from the item audit service 420_{b}, including a confidence score and rule updates can be stored in the storage device 422ₐ. The system-of-record layer 410 can further include a system-of-record module 430 configured to execute a service 420ₕ to subscribe to events and pull information from the RATE engine 116.

According to the non-limiting aspect of FIG. 4, the architecture 400 can be configured to enhance transaction security and reduce fraud. For example, at step 4.1, a presenting channel 101 from the user interface layer 402 can either generate or receive information associate with a transaction. For example, the presenting channel 101 can collect an image of an item (e.g., a check) associated with the transaction and/or customer in session, as applicable, and initiate item submission via the API 114 (FIG. 1). At step 4.2, the service 414 of the outer layer 404 can pass the item image and transaction information into the RATE engine 116 for enrichment. The item analysis module 326 of the RATE engine 116, at step 4.3, can inspect the transaction data, including any images, as well as included elements, using a machine-learning model and historically presented items for analysis and subsequently, returns information back to RATE. At step 4.4, the party analysis module 308 can inspect the parties involved in the transaction, including the presenter and/or payee if captured in the channel 101 and the payor or account on the item. Based on inputs from the item analysis module 326 and the party analysis module 308, at step 4.5, the RATE engine 116 can calculate a collection confidence score based on configured rules in the storage device 422ₐ and other information sent by the channel 101, including a unique identifier, such as a RATE_ID. At step 4.6, the RATE engine 116 can publish these insights to the data processing layer 408 for subsequent consumption by a subscribed system-of-record module 430 of the system-of-record layer 410 at step 4.7.

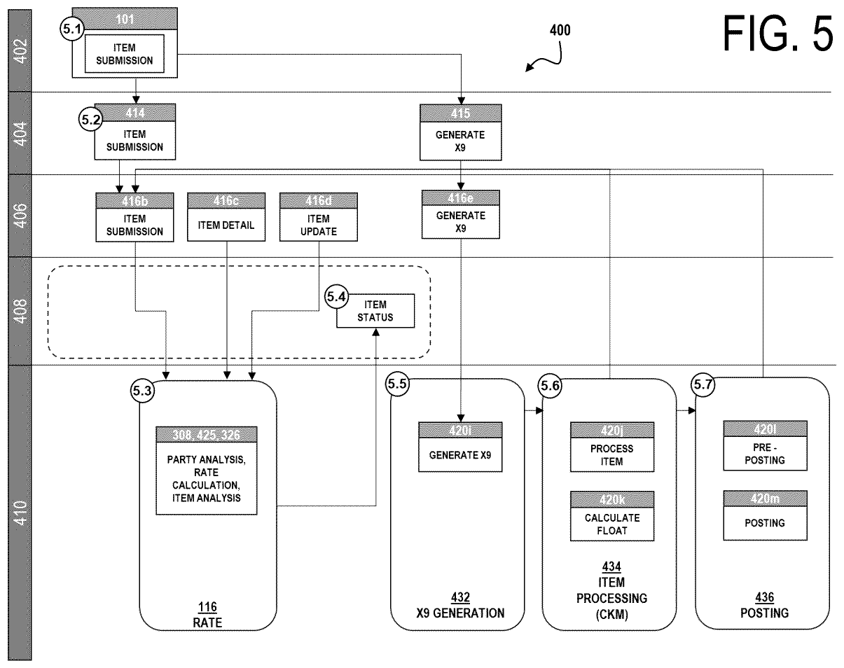

Referring now to FIG. 5, a second portion of an architecture 400 of the system 100 of FIG. 1 is depicted according to at least one non-limiting aspect of the present disclosure. According to the non-limiting aspect of FIG. 5, the outer layer 404 can further include a write service 415 configured to receive an X9 file request associated with the item submission from service 414 based on information received from the channel 101 via the API 114 (FIG. 1) and disposition the X9 file to the system-of-record layer 410 for processing. It shall be appreciated that X9 and, specifically, X9.37 files, are a format used to exchange transaction data associated with items (e.g., images of a check, reasons why a financial institution denied a transaction, etc.). The inner layer 406 can include a write service 416ₑ configured to transmit the X9 file request to the system-of-record layer 410.

Furthermore, according to FIG. 5, the system-of-record layer 410 can further include an X9 generation module 432, an item processing module 434, and/or a posting module 436. The X9 generation module 432 can include a service 420ᵢ configured to receive and process the X9 file. The item processing module 434 can include a service 420ⱼ configured to process items and a service 420ₖ configured to calculate float. The posting module 436 can include a service 420ₗ configured for pre-posting operations and a service 420ₘ configured for posting operations.

According to the non-limiting aspect of FIG. 5, the architecture 400 can be configured to further enhance transaction security and reduce fraud. For example, at step 5.1, the presenting channel 101 from the user interface layer 402 once again generates or receives information associate with a transaction. For example, the presenting channel 101 can collect an image of an item (e.g., a check) associated with the transaction and/or customer in session, as applicable, and initiate item submission via the API 114 (FIG. 1). At step 5.2, the service 414 of the outer layer 404 can once again pass the item image and transaction information into the RATE engine 116 for enrichment. The RATE engine 116, at step 5.3, can enrich the transaction via the party analysis module 308, the RATE calculation module 425, and the item analysis module 326 by generating transaction insights, such as a confidence score and a unique identifier, such as a RATE_ID At step 5.4, the RATE engine 116 can then publish transaction insights, including the confidence score and the unique identifier (e.g., a RATE_ID), to the data processing layer 408.

As depicted in FIG. 5, the X9 generation module 432 of the system-of-record layer 410 can employ the service 420ᵢ to receive the X9 file request from the write service 416ₑ of the inner layer 406 and generate an X9 file associated with the item submission from service 414, including the unique identifier. The item processing module 434 can include a service 420ⱼ to process items and a service 420ₖ calculate float (e.g., money temporarily counted due to processing delays). Specifically, the item processing module 434 can use the unique identifier to identify and route items, including details and records, at step 5.6. If an item is submitted to the item processing module 434 without a unique identifier, the item processing module 434 could initiate steps 5.2 and 5.3 for generation of a unique identifier. Processed items can be subsequently transmitted to the posting module 436. The posting module 436 of the system-of-record layer 410 can employ a service 420ₗ for pre-posting and a service 420ₘ for posting information, including processed items, received from the item processing module 434. Thus, at step 5.7, the posting module 436 can receive and post or pre-post item data from the item processing module 434. If an item is submitted to the posting module 436 without a unique identifier, the posting module 436 could initiate steps 5.2 and 5.3 for generation of a unique identifier.

In various aspects, therefore, the present disclosure is directed to a computer-implemented method for enhancing transaction security and reducing fraud for financial transactions, where the financial transaction can be made through any of a plurality of financial transaction channels, the method including: receiving, via a computer system that includes a programmed processor, via an electronic data network, a data file including a data item, wherein the data item is captured by a financial transaction initiating channel from the plurality of financial transaction channels, wherein the data item is captured upon initiation of the financial transaction in which funds are transferred from a payor's account to a payee's account; identifying, via the programmed processor, data relevant to the financial transaction based on the data item, identifying, via the programmed processor, at least one source of data relevant to the financial transaction, capturing, via the programmed processor, data relevant to the financial transaction from the at least one source of data relevant to the financial transaction, calculating, via the programmed processor, a confidence score for the financial transaction based on the data determined to be relevant to the financial transaction, and transmitting, via the computer system, via the electronic data network, the confidence score to the financial transaction initiating channel, wherein the confidence score influences how the financial transaction is processed.

According to some non-limiting aspects, the data relevant to the financial transaction includes information associated with at least one party associated with the financial transaction, and the method further includes performing, via the programmed processor, an analysis of the at least one party associated with the financial transaction based on the data relevant to the financial transaction, and calculating the confidence score is further based on the analysis of the at least one party associated with the financial transaction.

According to some non-limiting aspects, the data relevant to the financial transaction includes information associated with the data item, and the method further includes performing, via the programmed processor, an analysis of the data item based on the data relevant to the financial transaction, and calculating the confidence score is further based on the analysis of the data item.

According to some non-limiting aspects, the data item includes an image of a check presented to a financial institution for payment, and the method further includes capturing, via an image sensor, the image of the check.

According to some non-limiting aspects, the financial transaction initiating channel includes a personal computing device including the image sensor, and the data item is captured via the image sensor of the personal computing device.

According to some non-limiting aspects, the financial transaction initiating channel includes a banking device communicably coupled to the image sensor, and the data item is captured via the image sensor communicably coupled to the banking device.

According to some non-limiting aspects, the financial transaction initiating channel includes an automatic transaction machine (“ATM”) including the image sensor, and the data item is captured via the image sensor of the ATM.

According to some non-limiting aspects, the at least one source of data relevant to the financial transaction includes a financial institution.

According to some non-limiting aspects, the data relevant to the financial transaction includes at least one of an account status, an account balance, a signature verification, or a data item verification, or combinations thereof.

According to some non-limiting aspects, the at least one source of data relevant to the financial transaction includes a third-party database.

According to some non-limiting aspects, the data relevant to the financial transaction includes at least one of an entity status, a credit score, an employment history, spending activity, social media activity, dark web activity, or a criminal record, or combinations thereof.

According to some non-limiting aspects, the method further includes generating, via the programmed processor, a security action based on the confidence score.

According to some non-limiting aspects, the method further includes autonomously implementing the security action.

According to some non-limiting aspects, the security action includes at least one of denying the financial transaction request, resetting a password, monitoring an implicated account, cancelling a credential associated with the implicated account, or establishing a maximum financial transaction amount for future financial transaction requests involving the implicated account.

According to some non-limiting aspects, the security action includes placing a hold on the payor's account, and the method further includes transmitting, via an ISO 8583 protocol, an instruction to place a hold on the payor's account to a financial institution associated with the payor's account.

According to some non-limiting aspects, various channels of the plurality of channels can utilize at least one of a plurality of formats to communicate messages, wherein the plurality of formats includes at least one of a real-time gross settlement (“RTGS”), a national electronic funds transfer (“NEFT”), an electronic clearing service (“ECS”), an immediate payment service (“IMPS”), a Society for Worldwide Interbank Financial Telecommunications (“SWIFT”), a short messaging service (“SMS”) banking, an Internet banking, and/or an automatic teller machine (“ATM”).

In various aspects, therefore, the present disclosure is directed to a system for enhancing transaction security and reducing fraud for financial transactions, the system including a plurality of financial transaction channels, an application programming interface (“API”), and a review, analysis and transaction enrichment (“RATE”) computing device communicably coupled to the plurality of financial transaction channels via the API, wherein the RATE computing device includes a processor; and a memory configured to store a RATE engine that, when executed by the processor, causes the RATE computing device to receive, via an electronic data network, a data item captured by a financial transaction initiating channel from the plurality of financial transaction channels, wherein the data item is captured upon initiation of the financial transaction in which funds are transferred from a payor's account to a payee's account, identify data relevant to the financial transaction based on the data item, identify at least one source of data relevant to the financial transaction, capture data relevant to the financial transaction from the at least one source of data relevant to the financial transaction, calculate a confidence score for the financial transaction based on the data determined to be relevant to the financial transaction, and transmit, via an electronic data network, the confidence score to the transaction initiating channel, wherein the confidence score influences how the financial transaction is processed.

According to some non-limiting aspects, the data item includes an image of a check presented to a financial institution for payment, and the financial transaction initiating channel can capture, via an image sensor, the image of the check.

According to some non-limiting aspects, the financial transaction initiating channel includes a personal computing device including the image sensor, and the data item is captured via the image sensor of the personal computing device.

According to some non-limiting aspects, the financial transaction initiating channel includes an automatic transaction machine including the image sensor, and the data item is captured via the image sensor of the automatic transaction machine.

The examples presented herein are intended to illustrate potential and specific implementations of the present invention. It can be appreciated that the examples are intended primarily for purposes of illustration of the invention for those skilled in the art. No particular aspect or aspects of the examples are necessarily intended to limit the scope of the present invention. Further, it is to be understood that the figures and descriptions of the present invention have been simplified to illustrate elements that are relevant for a clear understanding of the present invention, while eliminating, for purposes of clarity, other elements. While various aspects have been described herein, it should be apparent that various modifications, alterations, and adaptations to those aspects may occur to persons skilled in the art with attainment of at least some of the advantages. The disclosed aspects are therefore intended to include all such modifications, alterations, and adaptations without departing from the scope of the aspects as set forth herein.

What is claimed is:

1. A computer-implemented method for enhancing transaction security and reducing fraud for financial transactions, where the financial transaction can be made through any of a plurality of financial transaction channels, the method comprising:
receiving, via a computer system that comprises a programmed processor, via an electronic data network, a data file comprising a data item, wherein the data item is captured by a financial transaction initiating channel from the plurality of financial transaction channels, wherein the data item is captured upon initiation of the financial transaction in which funds are transferred from a payor's account to a payee's account;
identifying, via the programmed processor, data relevant to the financial transaction based on the data item;
identifying, via the programmed processor, at least one source of data relevant to the financial transaction;
capturing, via the programmed processor, data relevant to the financial transaction from the at least one source of data relevant to the financial transaction;
calculating, via the programmed processor, a confidence score for the financial transaction based on the data determined to be relevant to the financial transaction; and
transmitting, via the computer system, via the electronic data network, the confidence score to the financial transaction initiating channel, wherein the confidence score influences how the financial transaction is processed.

2. The computer-implemented method of claim 1, wherein the data relevant to the financial transaction comprises information associated with at least one party associated with the financial transaction, and wherein the method further comprises:
performing, via the programmed processor, an analysis of the at least one party associated with the financial transaction based on the data relevant to the financial transaction; and
calculating the confidence score is further based on the analysis of the at least one party associated with the financial transaction.

3. The computer-implemented method of claim 1, wherein the data relevant to the financial transaction comprises information associated with the data item, and wherein the method further comprises:
performing, via the programmed processor, an analysis of the data item based on the data relevant to the financial transaction; and
calculating the confidence score is further based on the analysis of the data item.

4. The computer-implemented method of claim 3, wherein the data item comprises an image of a check presented to a financial institution for payment, and wherein the method further comprises:
capturing, via an image sensor, the image of the check.

5. The computer-implemented method of claim 4, wherein the financial transaction initiating channel comprises a personal computing device comprising the image sensor, and wherein the data item is captured via the image sensor of the personal computing device.

6. The computer-implemented method of claim 4, wherein the financial transaction initiating channel comprises a banking device communicably coupled to the image sensor, and wherein the data item is captured via the image sensor communicably coupled to the banking device.

7. The computer-implemented method of claim 4, wherein the financial transaction initiating channel comprises an automatic transaction machine (“ATM”) comprising the image sensor, and wherein the data item is captured via the image sensor of the ATM.

8. The computer-implemented method of claim 1, wherein the at least one source of data relevant to the financial transaction comprises a financial institution.

9. The computer-implemented method of claim 8, wherein the data relevant to the financial transaction comprises at least one of an account status, an account balance, a signature verification, or a data item verification, or combinations thereof.

10. The computer-implemented method of claim 1, wherein the at least one source of data relevant to the financial transaction comprises a third-party database.

11. The computer-implemented method of claim 10, wherein the data relevant to the financial transaction comprises at least one of an entity status, a credit score, an employment history, spending activity, social media activity, dark web activity, or a criminal record, or combinations thereof.

12. The computer-implemented method of claim 1, further comprising:
generating, via the programmed processor, a security action based on the confidence score.

13. The computer-implemented method of claim 12, further comprising:
autonomously implementing the security action.

14. The computer-implemented method of claim 13, wherein the security action comprises at least one of denying the financial transaction request, resetting a password, monitoring an implicated account, cancelling a credential associated with the implicated account, or establishing a maximum financial transaction amount for future financial transaction requests involving the implicated account.

15. The computer-implemented method of claim 13, wherein the security action comprises placing a hold on the payor's account, and wherein the method further comprises:
transmitting, via an ISO 8583 protocol, an instruction to place a hold on the payor's account to a financial institution associated with the payor's account.

16. The computer-implemented method of claim 1, wherein various channels of the plurality of channels can utilize at least one of a plurality of formats to communicate messages, wherein the plurality of formats comprises at least one of a real-time gross settlement (“RTGS”), a national electronic funds transfer (“NEFT”), an electronic clearing service (“ECS”), an immediate payment service (“IMPS”), a Society for Worldwide Interbank Financial Telecommunications (“SWIFT”), a short messaging service (“SMS”) banking, an Internet banking, and/or an automatic teller machine (“ATM”).

17. A system for enhancing transaction security and reducing fraud for financial transactions, the system comprising:
a plurality of financial transaction channels;
an application programming interface (“API”); and
a review, analysis and transaction enrichment (“RATE”) computing device communicably coupled to the plurality of financial transaction channels via the API, wherein the RATE computing device comprises:
a processor; and
a memory configured to store a RATE engine that, when executed by the processor, causes the RATE computing device to:
receive, via an electronic data network, a data item captured by a financial transaction initiating channel from the plurality of financial transaction channels, wherein the data item is captured upon initiation of the financial transaction in which funds are transferred from a payor's account to a payee's account;
identify data relevant to the financial transaction based on the data item;
identify at least one source of data relevant to the financial transaction;
capture data relevant to the financial transaction from the at least one source of data relevant to the financial transaction;
calculate a confidence score for the financial transaction based on the data determined to be relevant to the financial transaction; and
transmit, via an electronic data network, the confidence score to the transaction initiating channel, wherein the confidence score influences how the financial transaction is processed.

18. The system of claim 17, wherein the data item comprises an image of a check presented to a financial institution for payment, and wherein the financial transaction initiating channel can capture, via an image sensor, the image of the check.

19. The system of claim 18, wherein the financial transaction initiating channel comprises a personal computing device comprising the image sensor, and wherein the data item is captured via the image sensor of the personal computing device.

20. The system of claim 18, wherein the financial transaction initiating channel comprises an automatic transaction machine comprising the image sensor, and wherein the data item is captured via the image sensor of the automatic transaction machine.
